(19) United States
(12) Patent Application Publication
(10) Pub. No.: US 2024/0299959 A1
(43) Pub. Date: Sep. 12, 2024

(54) NOTCHED DEFLECTOR FOR A WATER JET LANCE

(71) Applicant: KURIYAMA EUROPE COÖPERATIEF U.A., Amsterdam (NL)

(72) Inventor: Orestes Chamorro Canet, Amsterdam (NL)

(21) Appl. No.: 18/589,831

(22) Filed: Feb. 28, 2024

(30) Foreign Application Priority Data
Mar. 9, 2023 (ES) U202330390

(51) Int. Cl. B05B 1/26

(52) U.S. Cl. CPC B05B 1/265

(57) ABSTRACT

The invention relates to a notched deflector (1) for a water jet lance, comprising a circular part with a rod (2) and a head (3) provided with notches (4) that are distributed over the lateral surface of said head (3) and a circular projection (5) on the rear portion. Optionally, the circular projection (5) emerges right next to the rear area or base (4a) of the notches (4), in the area where the head (3) joins the rod (2). Optionally, the circular projection (5) covers a portion of the rear area or base (4a) of the notches (4) on the lateral side of the head (3).

### OBJECT OF THE INVENTION

The invention, as disclosed in the present specification, relates to a notched deflector for a water jet lance that adds advantages and features to the function for which it is intended, said advantages and features being described in detail later on and representing an improvement to the current state of the art.

The object of the present invention is a deflector device specifically designed to be incorporated into the cylindrical body of a water jet lance or nozzle, of the type that can be attached to the end of a fire extinguishing hose, to monitors or the like, the head of which is located below the conical surface of the lance body and is provided with a series of peripheral notches on the lateral side of said head to ensure the fragmentation of the jet and allow the formation of a protective screen in the form of mist with a greater water outlet speed than in other deflectors. Said deflector exhibits the particularity of having an improved structural configuration, specifically by incorporating a circular projection in the lower portion of the head, which, without affecting said greater water outlet speed, allows the water flow to be controlled more effectively, advantageously ensuring a more stable stream and a compact jet in the corresponding position.

### FIELD OF APPLICATION OF THE INVENTION

The field of application of the present invention falls within the sector of the industry dedicated to the manufacture of jet lances and accessories for similar hoses.

### BACKGROUND OF THE INVENTION

Document ES201230073, the proprietor of which is the applicant of the present invention, discloses a notched deflector which, unlike the conventional deflectors used in water jet lances that have rotary or fixed teeth systems protruding above the upper side of the deflector, has a series of notches distributed in a peripheral position on the lateral side of its head, which does not protrude from the conical surface of the lance body, whereby a cone of fine droplets propelled at greater speeds is obtained.

This speed of the fine water droplets is greater since they result from the different jets formed at the source and their formation is not determined by the striking against external teeth.

Although said deflector satisfactorily fulfils its function of improving the prior state of the art through the existence of the aforementioned hidden notches on the lateral side of its head, the problem is that below the outer surface of the lance body, there are aspects that can be improved and this is the essential objective of the present invention.

Specifically, with the deflector known according to the aforementioned document, a significant portion of the water passes through the slits that define the described notches and this causes the behaviour of the flow to change, changes that are more or less pronounced, depending on the effect position in which it is working, either the compact jet position or the mist screen position, and that in any case cause irregularity and a lack of stability in the outlet flow stream that would be desirable to avoid, since this has a direct impact on the effectiveness of the system.

The objective of the present invention is, therefore, the development of an improved notched deflector that avoids said problem by including a circular projection specifically designed for same.

### EXPLANATION OF THE INVENTION

The notched deflector for a water jet lance proposed by the invention is thus configured as the ideal solution for the aforementioned objective, with the characterising details that make it possible and distinguish it from what is already known being conveniently included in the final claims that accompany the present description.

Specifically, the invention proposes, as previously noted, a notched deflector designed to be incorporated into the cylindrical body of a water jet lance or nozzle, of those intended to be attached to the end of a fire extinguishing hose, to monitors or the like.

More specifically, the deflector of the invention is made up of, in a known manner, a cylindrical part that comprises a rod and a circular head with notches on its lateral surface, sized for its axial attachment inside a rolling cylinder that slides axially inside an external cylindrical body of the lance, said head of the deflector being located below the conical surface of the rolling cylinder and its rod being surrounded by an inner cylinder, such that said deflector and the rolling cylinder can move axially relative to each other to modify the shape of the water outlet stream through the space between the lateral side of the deflector with the notches and the rolling cylinder, being able to adopt at least a compact jet position, in which the water outlet stream is cylindrical, straight and thick, and a mist attack position, in which the stream is thinner and defines a cone having a variable angle.

Based on this configuration that is already known, the deflector object of the invention is distinguished by exhibiting, on the rear side of the head, a circular projection that covers a small portion of the notches in the area from which the water flow strikes along its path towards the outlet through the notches, where it is fragmented before emerging outside and whereby the hidden arrangement of the deflector notches continues to achieve a greater water outlet speed than in deflectors with conventional external projections. However, said rear projection located inside the rear portion of the deflector head also allows the water flow to be controlled more effectively, advantageously ensuring a greater and better concentration of the cylindrical water stream in its compact jet position and a more regular shape of the conical water stream in its mist attack position, which in both cases translates into better hydraulic behaviour of the lance.

Since said circular projection of the deflector covers a portion of the notches, it prevents the flow from directly striking them, thereby allowing the water flow to be effectively controlled in each position of the flow shifter, at the same time that it ensures a compact jet in the corresponding position of the effect shifter.

The notched deflector, for its part, generates a mist of fine droplets with great cooling and penetration power. All this is due to its staticity, since there is no movement, and therefore, there is no risk of breakage or foreign materials becoming lodged in the deflector.

### DESCRIPTION OF THE DRAWINGS

To complement the present description and make the features of the invention more readily understandable, this specification is accompanied by a set of drawings as an integral part thereof, in which the following has been represented in an illustrative and non-limiting manner:

FIG. 1 shows a partially sectioned schematic view, along a longitudinal cut, of an exemplary lance, the inside of which includes an exemplary embodiment of the notched deflector object of the invention, where its general configuration and arrangement inside the body of the lance are shown;

FIG. 2 shows an enlarged view of detail A indicated in FIG. 1, where the configuration of the deflector head and the projection provided on the rear side of the same are shown;

FIG. 3 shows an enlarged view of detail B indicated in FIG. 2, where the configuration of the projection provided on the rear side of the deflector head is shown even more precisely;

FIG. 4 shows a partially sectioned elevation view of an exemplary deflector according to the prior art, where its general configuration and, in particular, the lack of the projection on the rear portion of its head are shown;

FIGS. 5-A and 5-B show comparative views of the schematic representation of the path formed by the water stream in the compact jet position, with the deflector of the prior art and with the deflector object of the invention, respectively; and

FIGS. 6-A and 6-B show comparative views of the schematic representation of the path formed by the water stream, with the deflector of the prior art and with the deflector object of the invention, respectively, in this case in the mist attack position.

### PREFERRED EMBODIMENT OF THE INVENTION

In view of the aforementioned figures, and in accordance with the numbering adopted, a non-limiting exemplary embodiment of the notched deflector for a water jet lance of the invention is shown, which comprises that which is described in detail below.

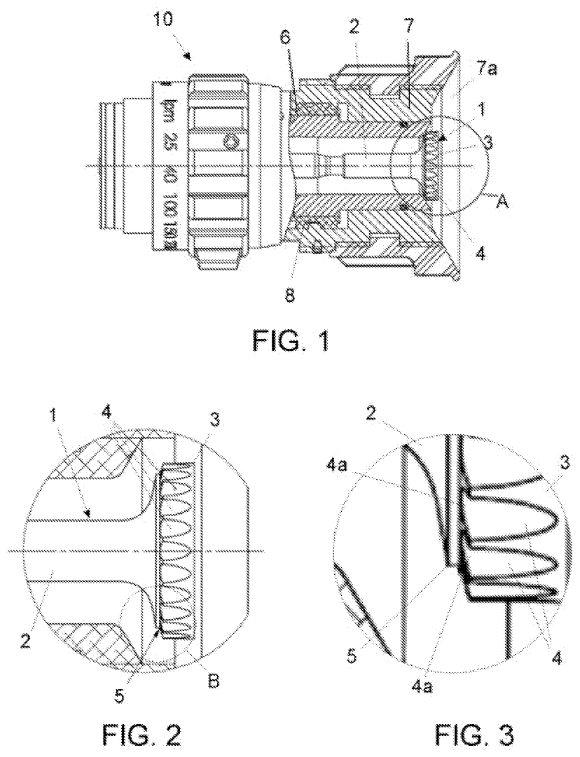

As shown in FIGS. 1 to 3, the deflector (1) of the invention consists of a circular part, made up of a solid of revolution, which comprises a narrow rod (2) and a head (3) provided with notches (4) that are distributed in a variable number over the lateral surface of said head (3), with the particularity that there is a circular projection (5) on the rear portion of said head (3).

The deflector (1) is designed to be incorporated into a lance (10) that basically consists of a main cylindrical body (6) on which a rolling cylinder (7) with a frustoconical upper base (7a), inclined inwards, slides axially, the deflector (1) being positioned axially inside the rolling cylinder (7) with its head (3) oriented towards the upper base (7a) of the rolling cylinder (7) and the rod (2) being surrounded by an inner cylinder (8), such that said cylindrical body (6) is located between the inner cylinder (8) and the rolling cylinder (7).

Thus, the axial sliding of the rolling cylinder (7) causes the head (3) of the deflector (1), which is fixed, to appear more or less, as desired, above the opening of the frustoconical surface of the base (7a) of the rolling cylinder (7) that is the element that moves to generate different effects, the notches (4) on the lateral side of said head (3) being more or less exposed in order to cause the water flow that passes through the lance (10) to define a stream in the form of a compact jet or a conical stream in the form of fine mist, and with the advantage that, due to the projection (5) on the rear side of the head (3) of the deflector (1) of the invention, said water flow is more regular when it strikes this projection (5) before fragmenting in the notches (4).

Preferably, as shown in the enlarged detail of FIG. 3, the circular projection (5) emerges right next to the rear area or base (4a) of the notches (4), in the area where the head (3) joins the rod (2) and such that it preferably covers a small portion of the rear area or base of the notches (4) on the lateral side of the head (3) of the deflector.

The notches (4) may be present in a variable number and at a variable angle (a) with respect to the perpendicular projection of the side of the head (3).

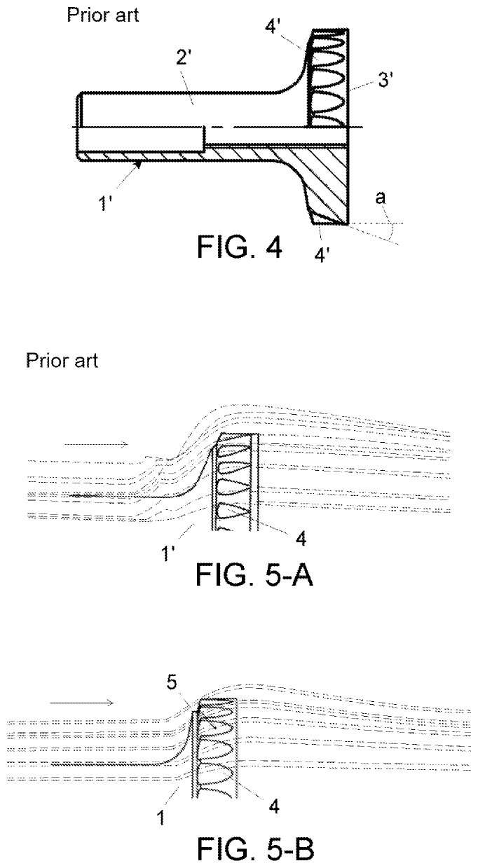

Taking into account FIG. 4, which shows an exemplary deflector (1′) according to the prior art, its lack of any projection between the notches (4′) of the head (3′) and the rod (2′) is shown.

Taking into account FIGS. 5-A and 5-B, the difference in the path formed by the water stream (represented by dashed lines) in the compact jet position between a lance that incorporates a deflector (1′) according to the prior art (FIG. 5-A) without a projection and when the lance incorporates a deflector (1) according to the invention (FIG. 5-B) is shown.

The jet position, with the deflector (1′) according to the prior art (FIG. 5-A), shows how a portion of the water passes through the slit notches (4′) and the jet exits at a more open angle, which causes greater dispersion of the stream at the outlet.

On the other hand, with the deflector (1) of the invention provided with the circular projection (5) (FIG. 5-B), a greater concentration of the stream is achieved since the water does not pass as much through the notches (4), and in said position, the projection (5) is the element that determines the operation of the lance and does so in a more regular way, since the flow is more stable. Thanks to the projection (5), a greater concentration of the water stream is achieved in the compact jet position.

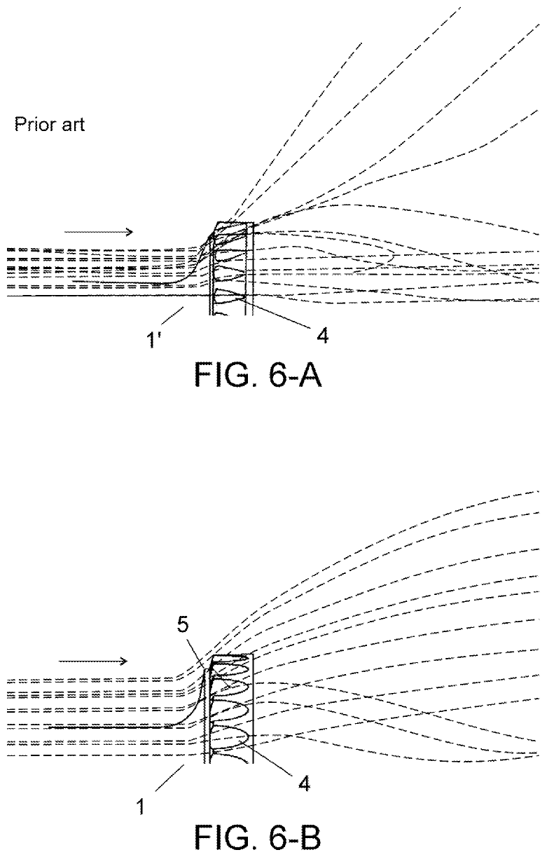

For its part, taking into account FIGS. 6-A and 6-B, it is possible to compare the difference in the path formed by the water stream in the mist attack position between a lance with a deflector (1′) according to the prior art (FIG. 6-A) and a deflector (1) with a projection (5) according to the invention (FIG. 6-B).

Therefore, it is shown that thanks to the circular projection (5), a greater concentration of the stream is achieved with the deflector (1) of the invention. In this case, the water passes more through the notches (4) than in the jet mode. The projection (5) is again the element that determines the hydraulic behaviour of the lance and does so in a more regular way, since the flow is more stable.

Having sufficiently described the nature of the present invention, as well as the manner of implementing it, no further explanation is required for a person skilled in the field to understand its scope and the advantages derived from the same.

1. A notched deflector for a water jet lance, which is made up of a circular part with a rod (2) and a head (3) provided with notches (4) that are distributed over the lateral surface of said head (3) and is applicable to a lance (10) with a main cylindrical body (6) and a rolling cylinder (7) with a frustoconical upper base (7a), inclined inwards, being positioned axially inside the cylindrical body (7) with the head (3) oriented towards the upper base (7a) of the rolling cylinder (7) and the rod (2) being surrounded by an inner cylinder (8), characterised in that said deflector (1) has a circular projection (5) on the rear portion of the head (3), such that when the water flow passes through the lance (10), it strikes said projection (5) before fragmenting in the notches (4), achieving a regular and stable stream, either in the form of a compact jet or in the form of fine mist.

2. The notched deflector for a water jet lance, according to claim 1, characterised in that the circular projection (5) emerges right next to the rear area or base (4a) of the notches (4), in the area where the head (3) joins the rod (2).

3. The notched deflector for a water jet lance, according to claim 2, characterised in that the circular projection (5) covers a portion of the rear area or base (4a) of the notches (4) on the lateral side of the head. (3).
